(19) United States
(12) Patent Application Publication
(10) Pub. No.: US 2009/0204679 A1
(43) Pub. Date: Aug. 13, 2009

(54) MAIL MANAGEMENT SYSTEM AND MAIL MANAGEMENT METHOD

(75) Inventors: Masashi MITOMO, Kawasaki (JP); Masahiro Komura, Kawasaki (JP); Satoru Torii, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/367,520

(22) Filed: Feb. 7, 2009

(30) Foreign Application Priority Data
Feb. 7, 2008 (JP) 2008-027913

(51) Int. Cl. G06F 15/16

(52) U.S. Cl. 709/206

(57) ABSTRACT

An electronic mail management system for managing electronic mail includes an obtaining unit, an assigning unit and a memory. The obtaining unit obtains electronic mail whenever the electronic mail is sent or received. The assigning unit assigns at least one serial number to the electronic mail obtained by the obtaining unit. Each assigned serial number is a number from a sequence of numbers associated with at least one mail address included in the obtained electronic mail. The memory stores the obtained electronic mail in connection with the at least one assigned serial number.

### CROSS-REFERENCE TO RELATED APPLICATIONS

This application is based upon and claims the benefit of priority from the prior Japanese Patent Application No. 2008-27913 filed on Feb. 7, 2008, the entire contents of which are incorporated herein by reference.

### FIELD

This invention relates to a mail management system and a mail management method.

### BACKGROUND

In the field of security, the importance of security has increased. Digital forensics, which is a relatively new concept, is related to the field of security in computers and networks. An example definition of forensic is “related to law” or “related to a court of justice”, and digital forensics is a generic term for technologies using digital data as evidence in a lawsuit or the like, for example. The technologies correspond, for example, to those of securely retaining and managing communication and other logs or for restoring data which has been purged from a hard disk.

One challenge in the field of digital forensics includes the realization of technologies for securing the evidential capacity of electronic mail usable in a lawsuit. In recent years, electronic mail has been an indispensable tool of communications in conducting business activities. For example, business transactions among companies are often conducted by using electronic mail. As a result, when a legal battle arises between companies having business relationships, electronic mail exchanged in the past between the companies is often submitted as important legal evidence.

Although there are an innumerable number of claim contents in lawsuits, patterns in which electronic mail is used as evidence generally falls into one of the following: (1) existence proof, a pattern which proves that mail from A to B exists, (2) non-existence proof, a pattern which proves that mail from A to B does not exist, and (3) total existence proof, a pattern which proves that mail from A to B is all the relevant mail.

It is noted that related technologies are described in Japanese Laid-open Patent Publication No. 2007-11693.

### SUMMARY

An embodiment of the present invention provides an electronic mail management system for managing electronic mail. The electronic mail management system includes an obtaining unit, an assigning unit and a memory. The obtaining unit obtains electronic mail whenever the electronic mail is sent or received. The assigning unit assigns at least one serial number to the electronic mail obtained by the obtaining unit. Each assigned serial number is a number from a sequence of numbers associated with at least one mail address included in the obtained electronic mail. The memory stores the obtained electronic mail in connection with the at least one assigned serial number.

Additional objects and advantages of the invention will be set forth in part in the description which follows, and in part will be obvious from the description, or may be learned by practice of the invention. The object and advantageous of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a pictorial drawing for explaining terms used in Embodiment 1.

FIGS. 2A to 2D are drawings for explaining a summary and features of a mail management system of Embodiment 1.

FIG. 3 is a block diagram for explaining a constitution of the mail management system of Embodiment 1.

FIG. 4 is a drawing for showing one example of information stored at a processed mail storage unit.

FIG. 5 is a drawing for showing one example of information stored at a counter snapshot storage unit of Embodiment 1.

FIG. 6 is a drawing for showing one example of information stored at a processing mail storage unit of Embodiment 1.

FIGS. 7A and 7B are drawings for showing one example of information stored at a counter storage unit of Embodiment 1.

FIGS. 8A to 8D are drawings for explaining a control unit of Embodiment 1.

FIGS. 9A to 9C are drawings for explaining the control unit of Embodiment 1.

FIGS. 10A to 10E are drawings for explaining the control unit of Embodiment 1.

FIG. 11 is a flow chart for showing the flow of mail retention processing by the mail management system of Embodiment 1.

FIG. 12 is a flow chart for showing the flow of snapshot retention processing by the mail management system of Embodiment 1.

FIG. 13 is a flow chart for showing the flow of proof creation and processing by the mail management system of Embodiment 1.

FIG. 14 is a drawing for explaining one feature of Embodiment 2.

FIG. 15 is a drawing for explaining one feature of Embodiment 3.

FIGS. 16A and 16B are drawings for explaining one feature of Embodiment 3.

FIG. 17 is a drawing for explaining a program of the mail management system of Embodiment 1.

### DETAILED DESCRIPTION OF EXAMPLES OF EMBODIMENTS

Incidentally, where the above-described related technologies are used to realize a method for proving one of the three above noted patterns or categories, especially, in the case of non-existence proof or total existence proof, it may be necessary to present all mail exchanged in the past to the other party. The disclosure of all mail in the past is not preferable in view of leakage of information and legal strategy. Further, the disclosure of all mail may be unrealistic in terms of efficiency. Disclosure of proof should be kept to an acceptable level and/or the minimum level possible. A method for addressing and/or solving the above challenge (and other challenges for that matter) is not disclosed in the related technology described in Japanese Laid-open Patent Publication No. 2007-11693.

Therefore, the inventor has invented a mail management system and a mail management method which are capable of providing proof, while reducing the amount of disclosure of evidence and/or keeping the amount of disclosure of evidence to the minimum amount possible.

Hereinafter, a detailed explanation is provided for examples of embodiments, which refers to attached drawings.

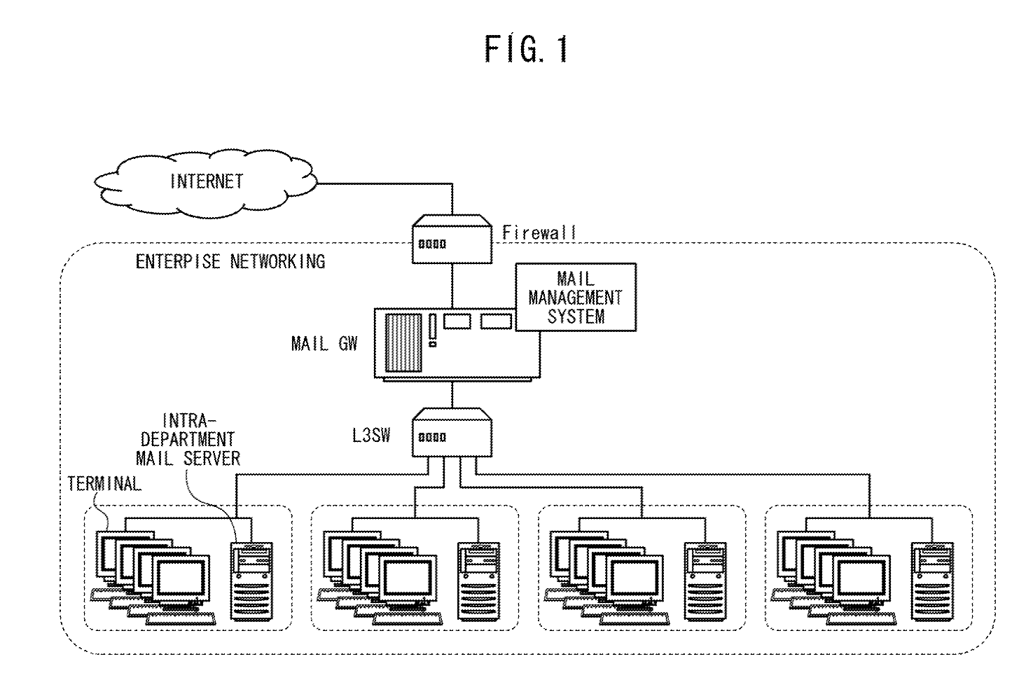

First of all, major terms are explained. The “mail management system” is an electronic mail management system and may include computers, servers and dedicated devices for managing electronic mail, for example. Next, for example, as shown in FIG. 1, a mail gateway (application gateway handling mail) installed at a boundary between the Internet and Intranet (enterprise networks) is described.

In the example shown in FIG. 1, the mail management system of Embodiment 1 is connected to the interior (i.e., on the side of an Intranet) of a firewall installed at a boundary between the Internet and an Intranet. Further, the mail management system of Embodiment 1 is connected to a switching device L3SW for controlling data transactions between individual terminals (e.g., computers) connected to an Intranet and between individual intra-department mail servers installed at each department in a company, for example. The mail management system according to Embodiment 1 obtains (captures) internal mail (e.g., incoming mail from the Internet to an Intranet, or mail sent to a computer connected to the Intranet) and external mail (e.g., outgoing mail from an Intranet to the Internet, or mail sent from a computer connected to an Intranet) without omission.

In the embodiments explained hereinafter, the mail management system of Embodiment 1 is explained as being at a boundary between the Internet and an Intranet. However, the present invention shall not be limited to a mail management system at a boundary between the Internet and Intranet. For example, the mail management system may be that which is able to obtain electronic mail sent to or received from a mail address to be managed (or a computer) and may not necessarily be at a boundary between the Internet and an Intranet.

The mail management system may be installed, for example, at each terminal which sends and receives electronic mail. Further, when explained by referring to the example given in FIG. 1, the mail management system is not limited to a case where it is connected in series between a firewall and a switching device, but may be connected to a line divergently connected to a line between the firewall and the switching device, for example.

Further, a “mail address” is identification information for uniquely identifying a destination and an originator of sent or received electronic mail on a network (for example, on the Internet). For example, electronic mail includes sender information which is a mail address identifying a sender who sends electronic mail and recipient information which is a mail address identifying a recipient who receives electronic mail. It is noted that, for example, the sender information may be a mail address extracted from the header of electronic mail or a field of “From”, and the recipient information may be extracted from the header of electronic mail or a field of “To”, “Cc” or “Bcc”.

Still further, “time information” is information which proves that electronic mail exists at a specified time. For example, the “time information” corresponds to information assigned as digital proof (time stamp) by a time stamp service which is a service for proving that certain electronic data exists at a certain time.

In addition, a “digital signature” is information which indicates that no tampering has been found. Specifically, it is information which indicates that the relevant electronic mail is retained by a specific mail management system. The digital signature may be created by using a secret key possessed by the specific mail management system. For example, the secret key may be possessed only by the mail management system. For example, the digital signature is created with a secret key in a public key encryption scheme, and it proves a creator of a document and may also indicate that no tampering has been found relating to the document.

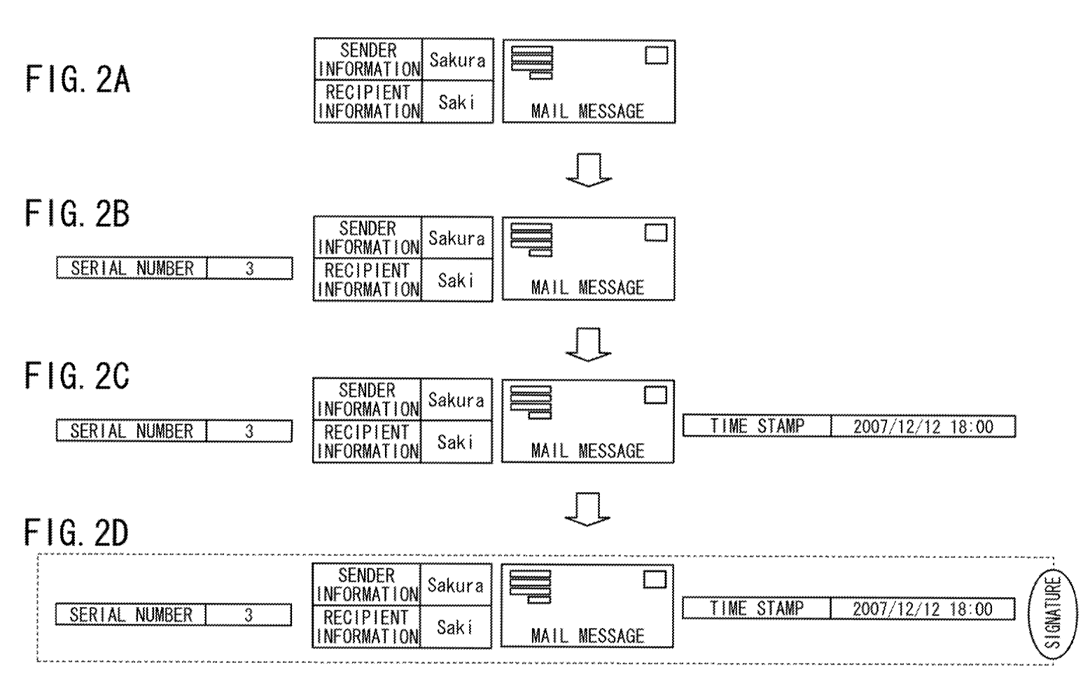

Next, an explanation is provided regarding a summary and features of the mail management system of Embodiment 1 with reference to FIG. 2. The mail management system of Embodiment 1 is an electronic mail management system for managing electronic mail. The mail management system includes features to provide proof, and keep the disclosure of evidence to an acceptable level and/or a minimum level possible.

The mail management system of Embodiment 1 obtains electronic mail sent from a mail address to be managed or incoming electronic mail to the relevant mail address when electronic mail is sent or received. For example, as shown in FIG. 2A, the mail management system of Embodiment 1 obtains a mail message (e.g., all data including a mail header and a mail body, for example) and a mail address included in the mail header with respect to mail sent (or received) from a mail address to be managed. In the example given in FIG. 2, the mail management system of Embodiment 1 obtains a mail message, obtains “Sakura” as sender information from a field of “From” included in the mail header, and also obtains “Saki” as recipient information from a field of “To” included in the mail header.

Then, the mail management system of Embodiment 1 assigns to the obtained electronic mail a serial number. The serial number is a number or sequence of numbers independently assigned to each mail address included in electronic mail. In the example given in FIG. 2B, the mail management system of Embodiment 1 assigns a serial number “3” to the obtained mail address including a combination of sender information “Sakura” and recipient information “Saki”.

It is noted that the mail management system is to assign a mutually independent serial numbers to the obtained electronic mail. Therefore, for example, after a serial number 3 is assigned to a combination of sender information “Sakura” and recipient information “Saki” of a first obtained electronic mail, if a second electronic mail including the combination of sender information “Sakura” and recipient information “Saki” is obtained, a different serial number from the same sequence of serial numbers is assigned to the second obtained email. For example, “4”, or a value obtained by adding “1” to “3”, is assigned as a serial number that is different from and subsequent to the serial number “3” assigned to the first obtained electronic mail including the sender information “Sakura” and the recipient information “Saki”.

On the other hand, the mail management system will not assign a serial number from the sequence of serial numbers associated with the combination of sender information, “Sakura”, and recipient information, “Saki”, to other combinations (for example, a combination of sender information “Patent” and recipient information, “Trademark”. Rather the mail management system will assign a serial number from a different sequence of serial numbers associated with the other combination (for example, the combination of sender information, “Patent”, and recipient information, “Trademark”.

Then, as shown in FIG. 2C, the mail management system according to Embodiment 1 assigns time information to the obtained electronic mail. The time information indicates and/or proves that the relevant electronic mail exists at specified time. Specifically, in the example given in FIG. 2C, the mail management system according to Embodiment 1 is assigned “2007/12/12 18:00” as a time at which electronic mail is obtained from a time stamp service, for example.

Then, as shown in FIG. 2D, the mail management system according to Embodiment 1 assigns a digital signature that indicates no tampering has been found with respect to electronic mail to which a serial number and also time information have been assigned. Specifically, in the example given in FIG. 2D, a digital signature indicating that no tampering has been found with respect to a serial number, a mail address, a mail message or a time stamp is assigned to the serial number, the mail address, the mail message and the time stamp (in FIG. 2D, “signature” is depicted inside the circle).

Then, the mail management system according to Embodiment 1 stores at a mail storage unit the electronic mail to which the digital signature has been assigned.

As described so far, the mail management system of Embodiment 1 provides proof while keeping the disclosure of evidence to an acceptable and/or minimum level. Specifically, the mail management system may prove the non-existence and total existence of an electronic mail without the disclosure of all electronic mail. In other words, electronic mail may be provided as strong evidence in a lawsuit without the disclosure of unnecessary information.

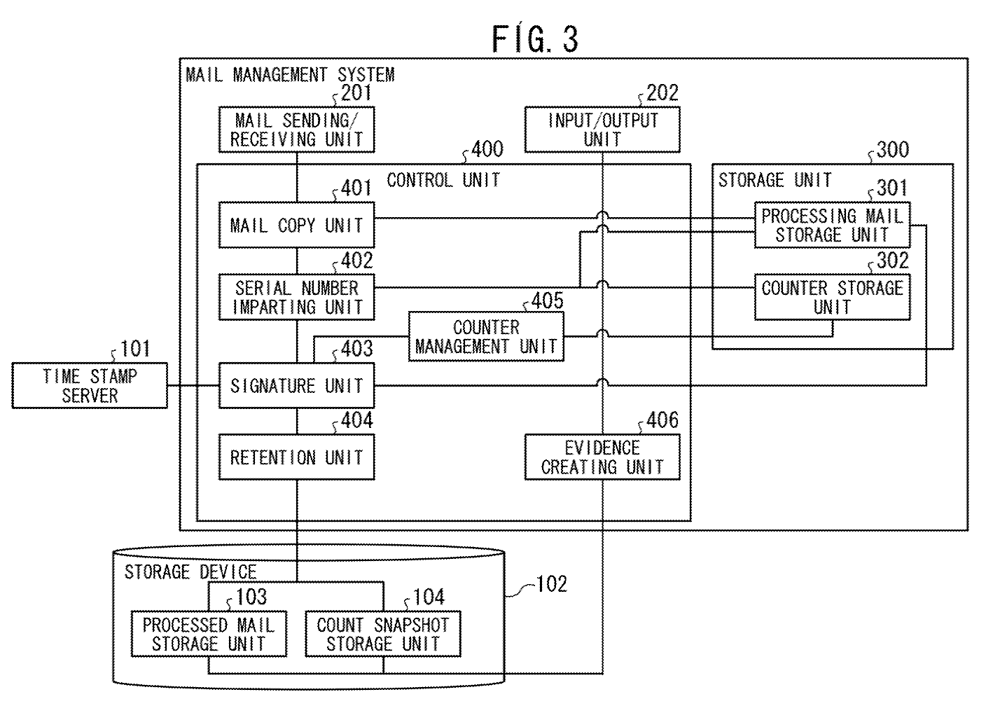

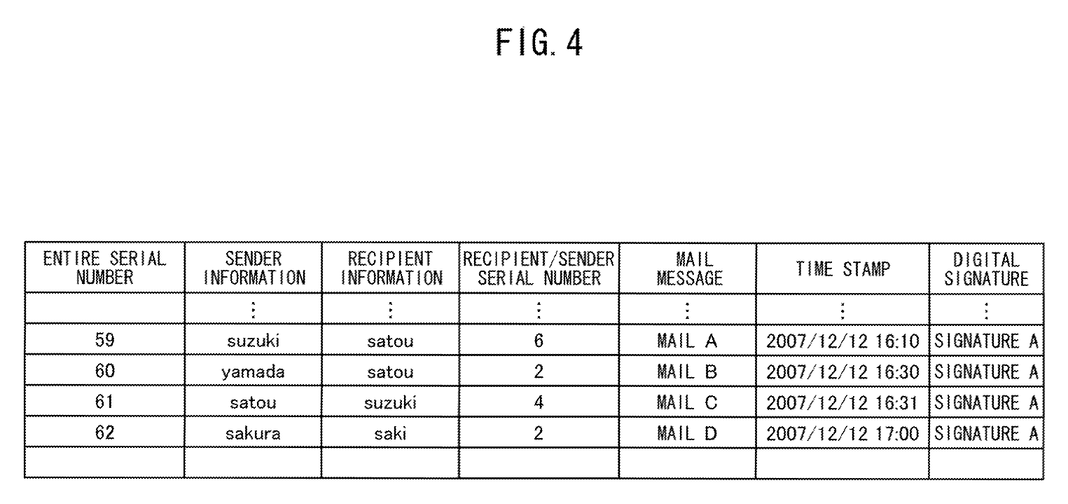

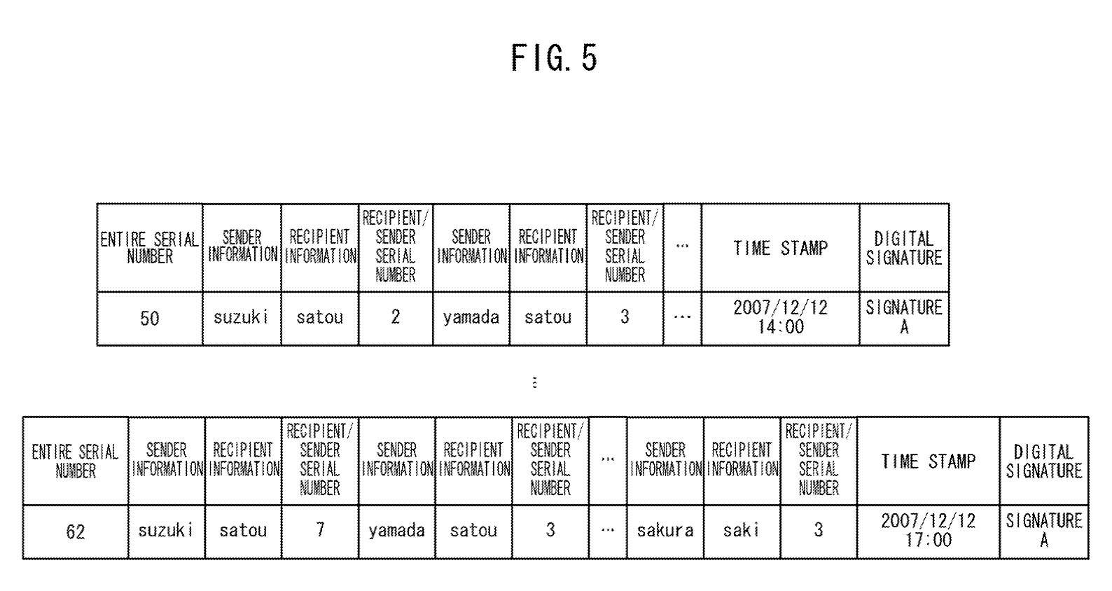

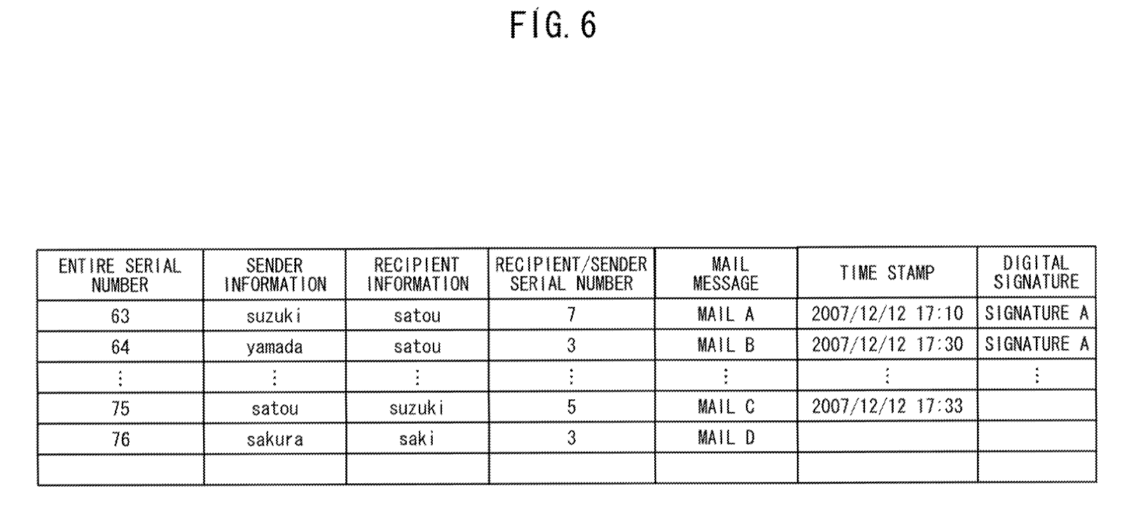

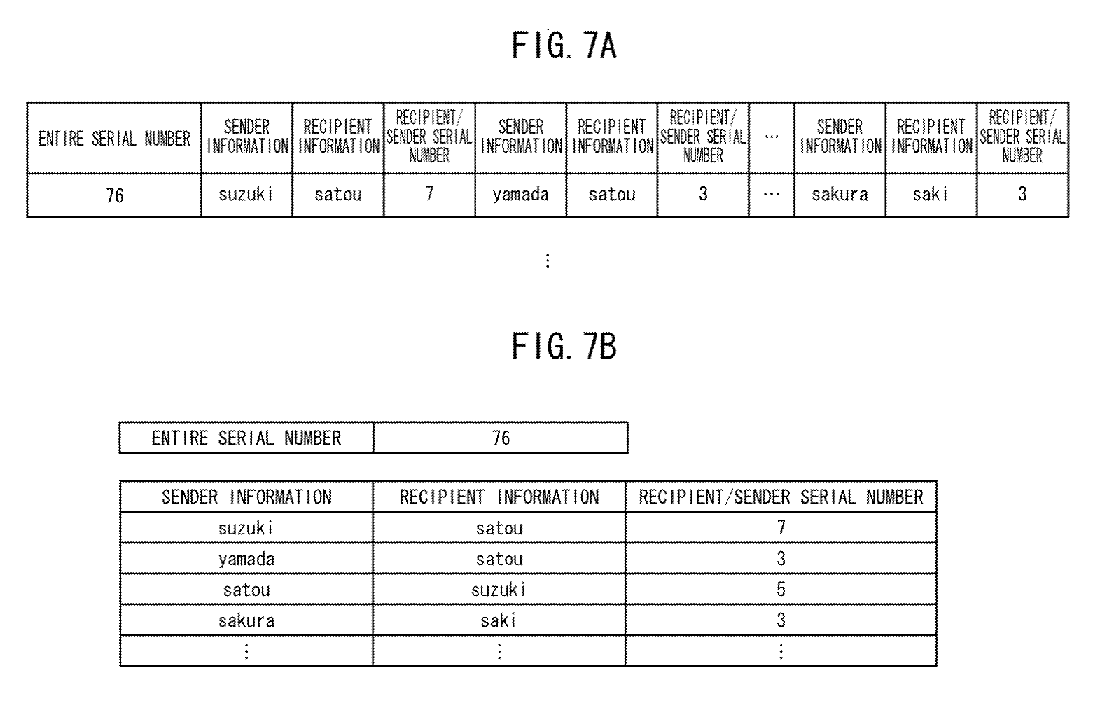

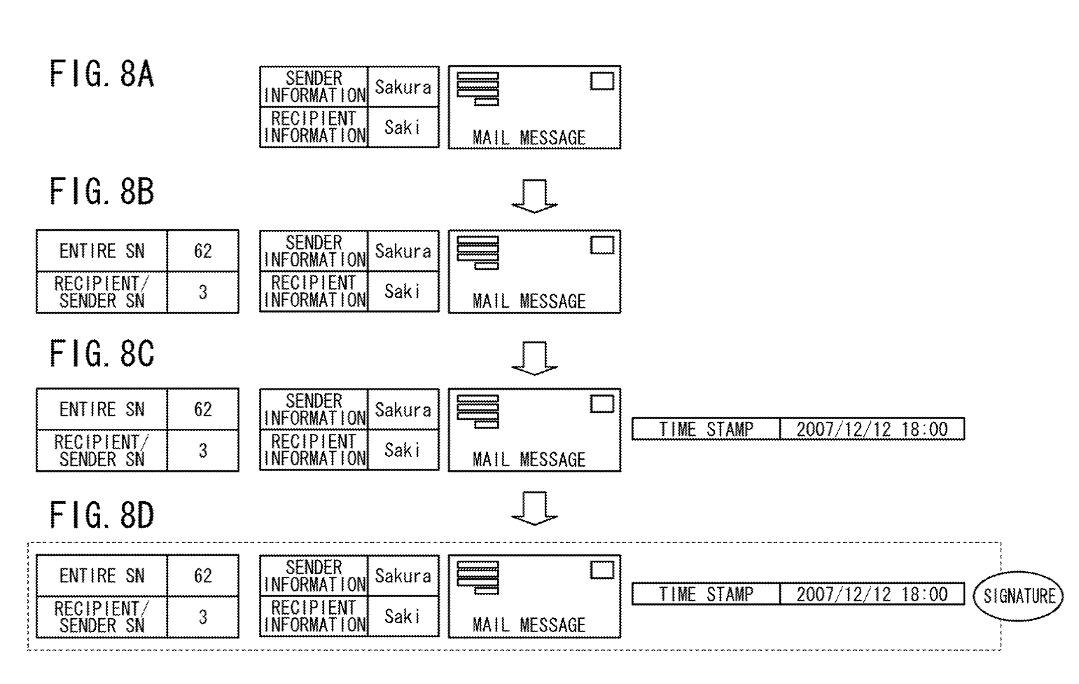

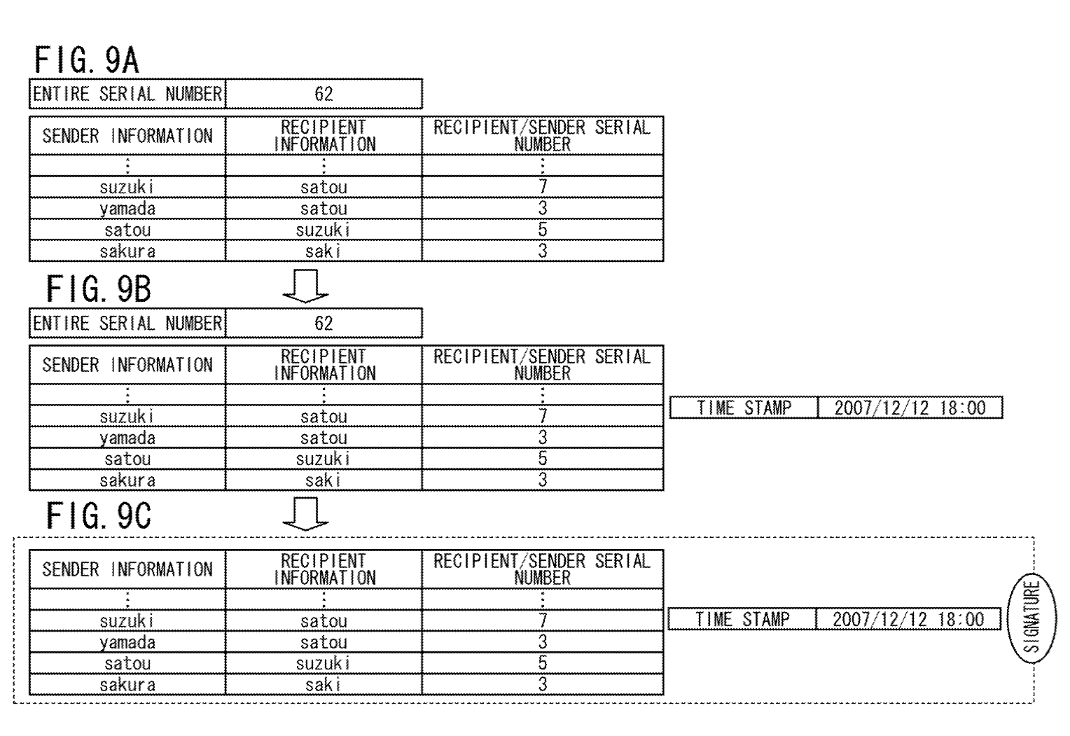

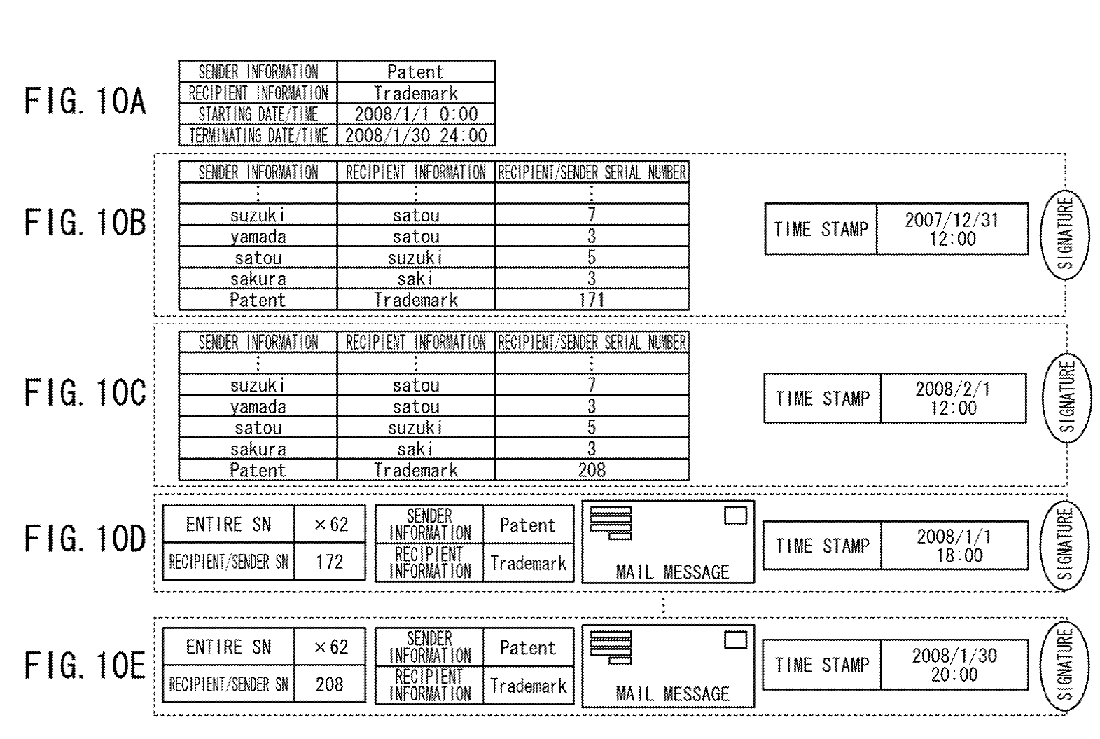

Next, an explanation is provided for a configuration according to the mail management system given in FIGS. 2A to 2D with reference to FIG. 3 to FIG. 10E. FIG. 3 is a block diagram for explaining a configuration of the mail management system of Embodiment 1. FIG. 4 is a drawing depicting one example of information stored at a processed mail storage unit. FIG. 5 is a drawing depicting one example of information stored at a counter snapshot storage unit of Embodiment 1. FIG. 6 is a drawing depicting one example of information stored at a processing mail storage unit of Embodiment 1. FIGS. 7A and 7B are drawings depicting one example of information stored at a counter storage unit of Embodiment 1. FIGS. 8A to 8D are drawings for explaining a control unit of Embodiment 1. FIGS. 9A to 9C are drawings for explaining the control unit of Embodiment 1. FIGS. 10A to 10E are drawings for explaining the control unit of Embodiment 1.

As shown in FIG. 3, the mail management system is connected to a time stamp server 101 and a storage device 102. In FIG. 3, the mail management system includes a mail sending/receiving unit 201, an input/output unit 202, a control unit 400 and a storage unit 300. It is noted that in the following embodiments, an explanation is provided for a case where the mail management system does not include the time stamp server 101 or the storage device 102, but rather, the mail management system is connected to the time stamp server 101 and the storage device 102, which are external to the mail management system. However, the mail management system shall not be limited to a case where it is connected to the external time stamp server 101 and the storage device 102. Rather, the mail management system may include one or both of the time stamp server 101 and the storage device 102.

The time stamp server 101 is a device for certifying a time with, for example, a server providing a time stamp service.

The storage device 102 is a memory which stores processed mail or other information processed by a control unit 400 described later. Specifically, the storage device 102 is a memory in which data is provided by a retention unit 404 described later and is also read by an evidence creating unit 406 described later. For example, an auxiliary storage device such as a HDD (Hard Disk Drive) may correspond to the storage device 102.

The storage device 102 is provided with a processed mail storage unit 103 and a counter snapshot storage unit 104.

The processed mail storage unit 103 stores electronic mail to which a digital signature has been assigned by a signature unit 403 described later. For example, as shown in FIG. 4, the processed mail storage unit 103 stores an “entire serial number”, “sender information”, “recipient information”, a “recipient/sender serial number”, a “mail message”, and a “time stamp” as information relating to processed mail which has been processed by the control unit 400. The processed mail storage unit 103 stores this information together with a “digital signature” assigned by the signature unit 403 with respect to all correspondence to the processed mail. The “entire serial number” is a number indicating a sequence of serial numbers assigned sequentially by a serial number assigning unit 402 described later, without discrimination of a mail address, when the mail management system obtains mail. The “recipient/sender serial number” is a sequence of numbers independent of each mail address or a number showing a serial number assigned by the serial number assigning unit 402 described later. It is noted that the processed mail storage unit 103 may store the above-described information on all mail obtained by the mail management system.

A specific explanation is provided with reference to an example. As data of the second record item from the top of the example table example given in FIG. 4, the processed mail storage unit 103 stores information including the entire serial number “59”; sender information “suzuki”; recipient information “satou”; recipient/sender serial number “6”; mail message “mail A”; time stamp “2007/12/12 16:10”, together with the digital signature “signature A”.

In this instance, an explanation is provided of a difference between the entire serial number and the recipient/sender serial number. The entire serial number is not a sequence of serial numbers independent of each mail address. Therefore, in the example given in FIG. 4, the entire serial number is assigned by the serial number assigning unit 402 described later with respect to mail obtained by the mail management system as a sequence of continuous numbers (for example, “59”, “60” and “61” . . . ), irrespective of the “sender information” and/or the “recipient information”.

In contrast, the recipient/sender serial number is a sequence of serial numbers independent of each mail address. In the example given in FIG. 4, a sequence of independent numbers are assigned to each combination of “sender information” and “recipient information” by the serial number assigning unit 402. For example, where there is a difference in a combination of “sender information” and “recipient information”, the recipient/sender serial numbers will be assigned as a sequence of independent serial numbers which are mutually different by the serial number assigning unit 402.

A specific explanation is provided with reference to the example given in FIG. 4. The mail management system assigns “2” as a recipient/sender serial number with respect to a combination of sender information “yamada”, and recipient information “satou” of an obtained electronic mail when the obtained electronic mail is the second electronic mail with the sender information of “yamada” and the recipient information of “satou”. Similarly, the mail management system assigns “2” as a recipient/sender serial number with respect to the combination of sender information “sakura” and recipient information “saki” when the obtained electronic mail is the second obtained electronic mail including the sender information “sakura” and the recipient information “saki”.

The counter snapshot storage unit 104 stores a snapshot created by a counter management unit 405 described later. For example, the counter snapshot storage unit 104 stores a snapshot at a specified time. The snapshot is information stored by a counter storage unit 302 described later. The counter snapshot storage unit 104 stores, for example, a snapshot of the entire serial number and also stores a snapshot on the correspondence of a mail address to a recipient/sender serial number.

For example, a snapshot may be created every time a backup operation is performed for the counter storage unit 302 described later. The snapshot is created according to instructions of the counter management unit 405 described later. The snapshot is accommodated by the retention unit 404 and stored by the counter snapshot storage unit 104.

For example, as shown in FIG. 5, the counter snapshot storage unit 104 stores an “entire serial number”, a “recipient/sender serial number” corresponding to each “recipient/sender information”, and a “time stamp” as a snapshot and stores this information together with a “digital signature” assigned to the correspondence.

In the example given in FIG. 5, the counter snapshot storage unit 104 stores an entire serial number “50”, a recipient/sender serial number “2”, a combination of sender information “suzuki” and recipient information “satou”, a recipient/sender serial number “3”, a combination of sender information “yamada” and recipient information “satou”, and a time stamp “2007/12/12 14:00”, together with a digital signature “signature A”. Further, the counter snapshot storage unit 104 stores similar snapshots at different time points (e.g., the example depicted in FIG. 5 shows a snapshot at a time point “2007/12/12 17:00”).

The mail sending/receiving unit 201 sends and receives mail according to the instructions from a mail copy unit 401 described later. For example, when electronic mail is stored at the processing mail storage unit 301 by the mail copy unit 401 described later, the mail sending/receiving unit 201 sends the relevant electronic mail to an appropriate mail server according to SMTP (Simple Mail Transfer Protocol), for example.

The input/output unit 202 receives, for example, the input of parameters used for processing by an evidence creating unit 406. The input parameters may be input by a user using the mail management system. The input/output unit 202 may send the input parameters to the evidence creating unit 406 described later. The input/output unit 202 also outputs information (for example, the information is given on a display) according to instructions from the evidence creating unit 406.

For example, as parameters used for processing by the evidence creating unit 406, the input/output unit 202 receives sender information and recipient information with regard to an evidence-creating mail address and also receives starting date/time and terminating date/time with regard to an evidence creating period. The input/output unit 202 receives, for example, the sender information “Patent”, and the recipient information “Trademark”, and also receives the starting date/time “2008/1/1 0:00”, and the terminating date/time “2008/1/30 24:00”, (see FIG. 10A).

The storage unit 300 may store various types of information and mail processed by the control unit 400. The storage unit 300 includes a processing mail storage unit 301 and a counter storage unit 302.

The processing mail storage unit 301 is a storage unit for temporarily storing mail obtained by the mail management system. The storage unit 301 may be a memory, for example. It is noted that mail stored by the processing mail storage unit 301 (e.g., mail a control unit 400 is processing) is stored into the processing mail storage unit 301 by a mail copy unit 401, used by a serial number assigning unit 402 and a signature unit 403, stored into the storage device 102 by a retention unit 404 to be described later and deleted by the retention unit 404.

For example, as shown in FIG. 6, the processing mail storage unit 301 stores a “mail message”. “sender information” and “recipient information” for each mail accommodated by the mail copy unit 401 described later. The processing mail storage unit 301 also stores an “entire serial number” and a “recipient/sender serial number” assigned by the serial number assigning unit 402 as well as a “time stamp” and a “digital signature” assigned by the signature unit 403.

In this instance, an explanation is provided for the “entire serial number”, “recipient/sender serial number”, “time stamp” and “digital signature”, which correspond to the “mail message” stored at the processing mail storage unit 301. Mail stored at the processing mail storage unit 301 is that which is not terminated for processing by the control unit 400. The mail stored at the processing mail storage unit 301 may include mail to which the “entire serial number”, “recipient/sender serial number”, “time stamp” and “digital signature” have only been partially assigned and mail to which none of the “entire serial number”, “recipient/sender serial numbers”, “time stamp” or “digital signature” have been assigned.

A specific explanation is provided with reference to an example. In the example given in FIG. 6, the processing mail storage unit 301 indicates an entire serial number “63”, sender information “suzuki”, recipient information “satou”, recipient/sender serial numbers “7”, and time stamp, “2007/12/12 17:10” correspond to the mail message “mail A”, and stores the information together with a digital signature “signature A”. The processing mail storage unit 301 also indicates an entire serial number “75”, sender information “satou”, recipient information “suzuki”, recipient/sender serial numbers “5”, and time stamp “2007/12/12 17:33”, correspond to the mail message “mail C”, and stores the information without an assigned digital signature. Further, the processing mail storage unit 301 indicates an entire serial number “76”, sender information “sakura”, recipient information “saki”, and recipient/sender serial number “3” correspond to the mail message “mail D” and stores the information without the time stamp or the digital signature.

The counter storage unit 302 stores entire serial numbers. Specifically, among serial numbers assigned as the entire serial numbers, the counter storage unit 302 stores the updated number. For example, the counter storage unit 302 stores the entire serial number, “76” in the example given in FIG. 7A.

Further, the counter storage unit 302 stores each updated recipient/sender serial number among the individual recipient/sender serial numbers, which correspond to mail addresses. For example, as shown in FIG. 7A, the counter storage unit 302 stores an entire serial number and also stores each recipient/sender serial number corresponding to a combination of sender information and recipient information. It is noted that the counter storage unit 302 is that in which the stored entire serial numbers and each recipient/sender serial number are updated by a serial number assigning unit 402. For example the counter storage unit 302 may be updated when a serial number is assigned by the serial number assigning unit 402.

An explanation is provided with reference to an example. In the example given in FIG. 7A, the counter storage unit 302 stores a recipient/sender serial number “7” corresponding to a combination of sender information “suzuki” and recipient information “satou”, and a recipient/sender serial number “3” corresponding to a combination of sender information “yamada”, and recipient information “satou”. It is noted that the table given in FIG. 7B has the same content as the content described with respect to FIG. 7A, however, the display format has been changed.

The control unit 400 is provided with an internal memory for storing programs which specify various types of mail processing procedures and data, or a processing unit for executing various types of processing by using the various types of mail processing procedures and data. The control unit 400 also includes a mail copy unit 401, a serial number assigning unit 402, a signature unit 403, a retention unit 404, a counter management unit 405, and an evidence creating unit 406.

The mail copy unit 401 obtains electronic mail sent from a mail address to be managed or incoming electronic mail to the relevant mail address. The electronic mail may be obtained by the mail copy unit 401 whenever the electronic mail is sent or received. For example, the mail copy unit 401 obtains electronic mail from the mail sending/receiving unit 201, stores the obtained electronic mail in the processing mail storage unit 301, and sends the obtained electronic mail from the mail sending/receiving unit 201.

An explanation is provided with reference to an example. Where electronic mail sent from “Sakura” to “Saki” is obtained, as shown in FIG. 8A, the mail copy unit 401 provides the processing mail storage unit 301 with the obtained mail message and a combination of sender information “Sakura”, and recipient information “Saki”, included in the mail message. Further, the mail copy unit 401 sends the obtained electronic mail to “Saki” from the mail sending/receiving unit 201.

The serial number assigning unit 402 assigns an entire serial number to electronic mail obtained by the mail copy unit 401. For example, as shown in FIG. 8B, the serial number assigning unit 402 assigns an entire serial number “entire SN” to the electronic mail obtained by the mail copy unit 401. A specific explanation is provided with reference to an example. Where electronic mail which is sent from “Sakura” to “Saki”, for example, is the 62nd mail obtained by the mail copy unit 401, the serial number assigning unit 402 assigns an entire SN “62”, in the example given in FIG. 8B.

Further, the serial number assigning unit 402 assigns a recipient/sender serial number to electronic mail obtained by the mail copy unit 401. For example, the serial number assigning unit 402 assigns an independent recipient/sender serial number for each electronic mail obtained by the mail copy unit that includes the same combination of sender information and recipient information to the relevant electronic mail obtained by the mail copy unit 401.

A specific explanation is provided with reference to an example. Where the electronic mail obtained by the mail copy unit 401 is the third electronic mail including a combination of sender information “Sakura”, and recipient information “Saki”, the serial number assigning unit 402 assigns a recipient/sender serial number, “3” as shown in FIG. 8B.

In this instance, an explanation is provided for one example of serial numbers processed by the serial number assigning unit 402. The serial number assigning unit 402 assigns an entire serial number to mail being processed. In other words, the serial number assigning unit 402 refers to the updated entire serial number stored into the counter storage unit 302, thereby assigning a value obtained by adding “one” to the updated entire serial number to mail being processed as an entire serial number.

Where the entire serial number stored at the counter storage unit 302 is, for example, “63”, the serial number assigning unit 402 assigns “64” to the mail being processed as an entire serial number. Further, the serial number assigning unit 402 updates the updated entire serial number stored at the counter storage unit 302 from “63” to “64”, which is a value obtained by adding “1” to “63”.

Further, the serial number assigning unit 402 refers to a recipient/sender serial number of the counter storage unit 302. In other words, the serial number assigning unit 402 refers to a recipient/sender serial number corresponding to a mail address included in mail being processed, thereby judging whether or not there is a recipient/sender serial number corresponding to the relevant mail address. For example, where there is a recipient/sender serial number corresponding to the mail address, the serial number assigning unit 402 obtains the recipient/sender serial number and assigns a value obtained by adding “1” to the numbers to the mail being processed as a recipient/sender serial number.

For example, where the recipient/sender serial number, “2”, to corresponds to a combination of sender information and recipient information included in mail obtained by the mail copy unit 401 and stored at the counter storage unit 302, the serial number assigning unit 402 writes in the processing mail storage unit 301 a value “3” obtained by adding “1” to “2” which is a “recipient/sender serial number” corresponding to a combination of sender information and recipient information. Further, a value of the recipient/sender serial number corresponding to a combination of sender information and recipient information referred to and stored at the counter storage unit 302 is updated from “2” to a value “3” obtained by adding “1” to “2”.

Further, where there is no recipient/sender serial number corresponding to a combination of sender information and recipient information included in mail obtained by the mail copy unit 401, the serial number assigning unit 402 assigns a new recipient/sender serial number. In other words, the serial number assigning unit 402 assigns, for example, “1” to mail being processed as a recipient/sender serial number. The serial number assigning unit 402 writes in the processing mail storage unit 301, for example, a value “1” as a “recipient/sender serial number” corresponding to a combination of sender information and recipient information. Further, a combination of the thus referred sender information and recipient information and a recipient/sender serial number “1” corresponding to the combination of sender information and recipient information are newly written into the counter storage unit 302.

The signature unit 403 assigns time information to electronic mail obtained by the mail copy unit 401. For example, in the example given in FIG. 8C, the signature unit 403 obtains “2007/12/12 18:00” as time information from a time stamp server 101 and assigns the obtained time information to mail being processed. A specific explanation is provided with reference to an example. The signature unit 403 delivers to the time stamp server 101 mail being processed along with information such as an entire serial number, sender information, recipient information, a recipient/sender serial number and a mail message, for example, and requests the processing of time information (time stamp), thereby assigning the time information to the mail being processed.

Further, the signature unit 403 assigns a digital signature to indicate whether or not the email has been tampered with. The digital signature may be used to determine if tampering has been found with respect to electronic mail to which serial numbers (e.g., an entire serial number and a recipient/sender serial number) have been assigned and time information has been assigned by the serial number assigning unit 402. For example, in the example given in FIG. 8D, the signature unit 403 assigns a digital signature (in FIG. 8, “digital signature” is depicted inside the circle) to the entirety of mail being processed, which may include an entire serial number, sender information, recipient information, a recipient/sender serial number, a mail message and time information). The digital signature unit 403 may be assigned using a secret key of the digital signature unit 403.

The retention unit 404 provides the processed mail storage unit 103 with electronic mail to which a digital signature has been assigned by the signature unit 403. Further, the retention unit 404 provides at the counter snapshot storage unit 104 a snapshot created by a counter management unit 405 described later.

For example, the retention unit 404 reads out mail being processed to which a digital signature has been assigned by the signature unit 403 from the processing mail storage unit 301, provides the mail being processed to which the digital signature has been assigned to the processed mail storage unit 103, and deletes the provided mail from the processing mail storage unit 301.

It is noted that the retention unit 404 may create a retrieval index, with consideration given to the possibility that information stored in the processed mail storage unit 103 will be retrieved in the future. Providing a retrieval index allows quick retrieval of information stored in the processed mail storage unit 103 by an evidence creating unit 406 described later. Information may also be retrieved in response to a request of a user who uses the mail management system.

Further, in view of economizing the retention capacity, the retention unit 404 may retain mail being processing after the mail is subjected to data compression. Accordingly, the capacity of the processed mail storage unit 103 may be effectively utilized.

The counter management unit 405 creates a snapshot showing the correspondence of information stored at the counter storage unit 302 (e.g., an entire serial number and each recipient/sender serial number) at specified times. For example, a snapshot may be created when a backup operation is carried out for the counter storage unit 302. As another example, the counter management unit 405 may create a snapshot regularly at a specified interval/frequency. A specific explanation is provided with reference to an example. For example, the snapshot may be created once every hour (i.e., 24 times a day) or once daily.

In this instance, an explanation is provided for an example of creating and processing a snapshot by the counter management unit 405. At the time of creating the snapshot, as shown in FIG. 9A, the counter management unit 405 obtains the information (e.g., an entire serial number and each recipient/sender serial number) stored at the counter storage unit 302.

Further, as shown in FIG. 9B, the counter management unit 405 assigns a time stamp to the information (e.g., an entire serial number and each recipient/sender serial number) obtained at a time point when a snapshot is created and also assigns a digital signature, as shown in FIG. 9C.

It is noted that the counter management unit 405 may temporarily accommodate the obtained information (e.g., an entire serial number and each recipient/sender serial number) at the storage unit 300, thus assigning the time stamp and the digital signature.

The evidence creating unit 406 uses the information stored at the processed mail storage unit 103 and the counter snapshot storage unit 104 to create evidence relating to the existence proof of electronic mail, non-existence proof of electronic mail and total existence proof of electronic mail. For example, the evidence creating unit 406 creates evidence, which may be useful in a lawsuit, for example.

A specific explanation is provided with reference to an example. When parameters (e.g., desired conditions of evidence) for creating evidence by the input/output unit 202 are input, the evidence creating unit 406 obtains information based on the input parameters from the processed mail storage unit 103 and the counter snapshot storage unit 104, and outputs the information.

Here, an explanation is provided for one example in which evidence is created and processed by the evidence creating unit 406. For example, as shown in FIG. 10A, the evidence creating unit 406 accepts a combination of sender information “Patent”, and recipient information “Trademark”, and also accepts the starting date/time “2008/1/1 0:00”, and the terminating date/time “2008/1/30 24:00”, as parameters input from the input/output unit 202.

The evidence creating unit 406 reads out processed mail from the processed mail storage unit 103 according to the input parameters of evidence and also reads out a snapshot from the counter snapshot storage unit 104. For example, as shown in FIG. 10B, the evidence creating unit 406 obtains a first snapshot (e.g., the last-created snapshot in view of the time point of the input “starting date/time” at the time point of the input “starting date/time” and obtains another snapshot created after the input “terminating date/time”, as shown in FIG. 10C.

An explanation is provided for an example in which a snapshot is created at 12:00 by the counter management unit 405. As shown in FIG. 10B, the evidence creating unit 406 obtains a snapshot (referred to as snapshot A) at the time point of “2007/12/31 12:00”, which is the first snapshot in view of the input starting date/time “2008/1/1 0:00”. Further, as shown in FIG. 10C, the evidence creating unit 406 obtains from the counter snapshot storage unit 104, a snapshot (referred to as snapshot B) at the time point of “2008/2/1 12:00”, which is another snapshot created after the input terminating date/time of “2008/1/30 24:00”.

The evidence creating unit 406 obtains a recipient/sender serial number corresponding to a combination of the input “sender information” and “recipient information” from the snapshot A and the snapshot B. Then, the evidence creating unit 406 obtains from the processed mail storage unit 103 all electronic mail covering from the electronic mail correspond to a value obtained by adding “1” to the recipient/sender serial number obtained from the snapshot A to the electronic mail corresponding to the recipient/sender serial number obtained from the snapshot B.

For example, in the example given in FIG. 10B, the recipient/sender serial number corresponding to a combination of the thus input sender information “Patent”, and recipient information “Trademark”, is “171” in the snapshot A. Further, in the example given in FIG. 10C, the recipient/sender serial number corresponding to the combination of the input sender information “Patent” and recipient information “Trademark”, is “208” in the snapshot B. Therefore, regarding electronic mail including the combination of sender information “Patent”, and recipient information “Trademark”, the evidence creating unit 406 obtains, from the processed mail storage unit 103, all electronic mail from “172” of the recipient/sender serial number as shown in FIG. 10D to “208” of the recipient/sender serial number as shown in FIG. 10E.

The evidence creating unit 406 outputs as evidence a snapshot (FIG. 10B and FIG. 10C) obtained from the counter snapshot storage unit 104 and each processed electronic mail (FIG. 10D and FIG. 10E) obtained from the processed mail storage unit 103. For example, the evidence creating unit 406 may provide the evidence in a file that may be output as binary data, for example.

The evidence creating unit 406 outputs electronic mail to which such a recipient/sender serial number is assigned that corresponds to a combination of the input “sender information” and “recipient information”. The output electronic mail also corresponds to a period determined by the input starting date/time and the terminating date/time. In other words, electronic mail is not output that does not have the combination of the input “sender information” and “recipient information” or that is sent or received during a period other than determined period. Therefore, it is possible to provide the non-existence proof and total existence proof of electronic mail, while keeping the amount of disclosure of evidence to an acceptable and/or minimum level.

The mail management system may be realized by configuring information processing device to include the above-described mail copy unit 401, serial number assigning unit 402, signature unit 403, retention unit 404, counter management unit 405 and evidence creating unit 406. Examples of information processing devices include a personal computer, workstation, cellular phone, terminal of personal handy-phone system (PHS), terminal of mobile communication and personal digital assistant (PDA).

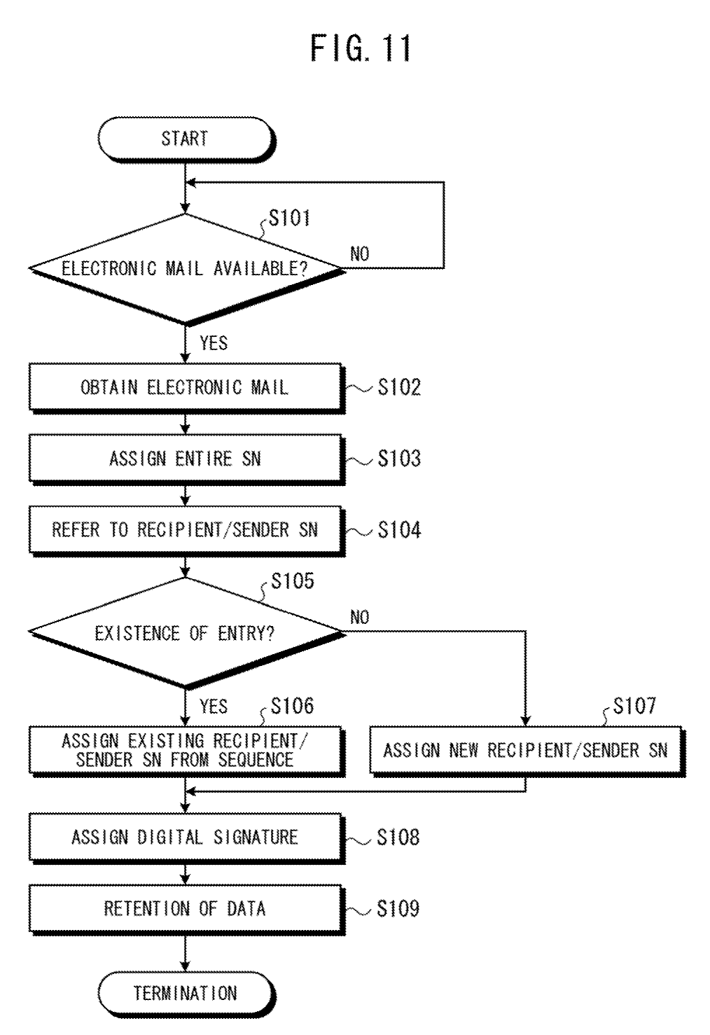

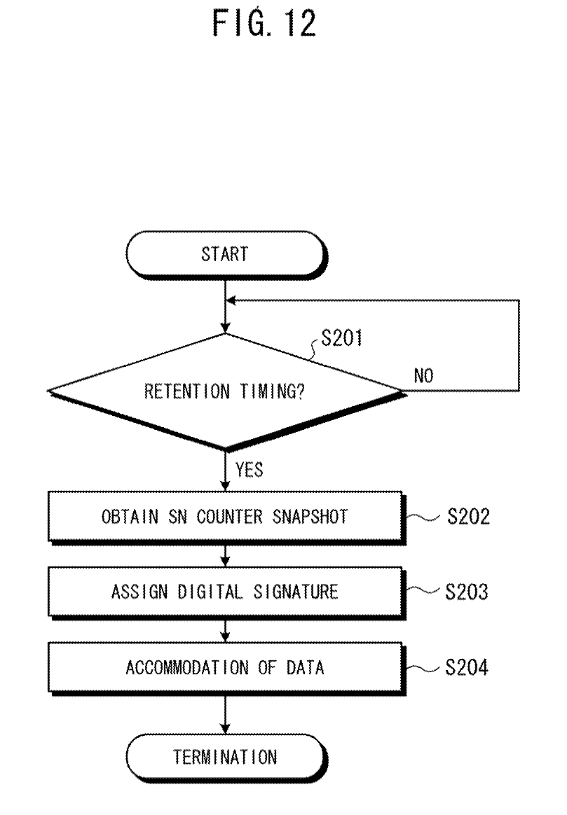

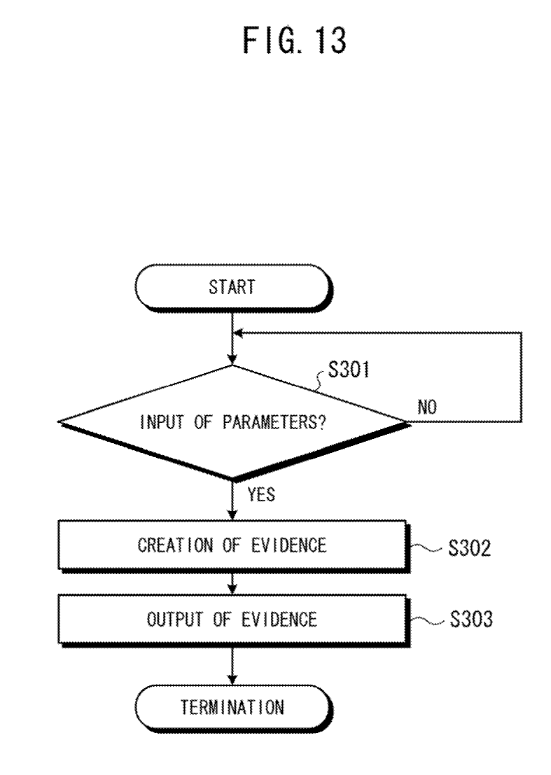

FIG. 11 is a flow chart depicting mail retention processing by the mail management system of Embodiment 1. FIG. 12 is a flow chart depicting snapshot retention processing by the mail management system of Embodiment 1. FIG. 13 is a flow chart depicting evidence creation processing by the mail management system of Embodiment 1.

As shown in FIG. 11, when electronic mail sent from a mail address to be managed or incoming electronic mail to the relevant mail address is present (Yes in S101), the mail copy unit 401 copies the electronic mail (S102). In other words, the mail copy unit 401 obtains electronic mail whenever the electronic mail is sent or received. For example, the mail copy unit 401 obtains electronic mail from the mail sending/receiving unit 201, stores the obtained electronic mail at the processing mail storage unit 301 and sends the obtained electronic mail from the mail sending/receiving unit 201.

Then, the serial number assigning unit 402 assigns an entire serial number to the electronic mail obtained by the mail copy unit 401 (S103). The serial number assigning unit 402 also refers to a recipient/sender serial number of the counter storage unit 302 (S104). In other words, the serial number assigning unit 402 refers to a recipient/sender serial number corresponding to the mail address included in mail being processed now processing and judges whether or not there is a recipient/sender serial number corresponding to the mail address.

If there is a recipient/sender serial number corresponding to the mail address (Yes in S105), the serial number assigning unit 402 assigns an existing recipient/sender serial number (S106). In other words, the serial number assigning unit 402 obtains the number corresponding to the mail address, adds “1” to the number and assigns the resultant number to the mail being processed as a recipient/sender serial number. On the other hand, where there is not a recipient/sender serial number corresponding to the mail address (No in S105), the serial number assigning unit 402 assigns a new recipient/sender serial number (S107). In other words, for example, where there is no recipient/sender serial number corresponding to the mail address, the serial number assigning unit 402 assigns “1” to the mail being processed as a recipient/sender serial number.

Once a serial number is assigned (S106 and S107), the signature unit 403 assigns time information and assigns a digital signature (S108).

Thereafter, the retention unit 404 provides the processed mail storage unit 103 with electronic mail to which a digital signature has been assigned by the signature unit 403 (S109).

As shown in FIG. 12, when a snapshot is created (Yes in S201), the counter management unit 405 obtains information (e.g., an entire serial number and each recipient/sender serial number) stored at the counter storage unit 302 (S202).

Then, the counter management unit 405 assigns a time stamp and a digital signature (S203). In other words, for example, the counter management unit 405 assigns a time stamp to the information (e.g., an entire serial number and each recipient/sender serial number) obtained at the time point of creation of the snapshot, as well as the digital signature. Thereafter, the counter management unit 405 accommodates the snapshot (S204).

As shown in FIG. 13, when parameters are input (Yes in S301), the evidence creating unit 406 creates evidence according to the input parameters (S302). For example, the evidence creating unit 406 reads out processed mail from the processed mail storage unit 103 and also reads out a snapshot from the counter snapshot storage unit 104 based on the input parameters.

Then, the evidence creating unit 406 outputs the created evidence (S303). For example, the evidence creating unit 406 outputs the evidence which has been read out from the processed mail storage unit 103 and the counter snapshot storage unit 104.

As described above, according to the mail management system, electronic mail sent from a mail address to be managed or incoming electronic mail to the relevant mail address may be obtained whenever the electronic mail is sent or received. Then, serial numbers which are a sequence of numbers independent of each mail address included in the electronic mail and time information are assigned to the obtained electronic mail. A digital signature is assigned to the electronic mail to which the time information has been assigned, and the electronic mail to which the digital signature has been assigned is stored in the storage device. Therefore, it is possible to provide proof, while keeping the disclosure of evidence to an acceptable and/or minimum level.

Further, according to the mail management system, since a serial number independent of each combination of sender information and recipient information is assigned to the obtained electronic mail, it is possible to provide the non-existence proof or total existence proof of electronic mail while keeping the disclosure of evidence to an acceptable and/or minimum level.

Specifically, it is possible to provide the non-existence proof or total existence proof of electronic mail, without the disclosure of all electronic mail. In other words, it is possible to provide electronic mail as strong evidence in a lawsuit, without the disclosure of unnecessary information.

For example, in a conventional or related method, the mail management system assigns a sequence of serial numbers to all electronic mail sent or received by an electronic mail management system. Thus, there is a necessity for disclosing all the mail in giving the non-existence proof or total existence proof of mail.

As compared with the conventional or related methods, the mail management system of examples of embodiments of the present invention may provide only the electronic mail including the combination of sender information and recipient information for which the non-existence proof or total existence proof of mail is desired. It is, therefore, possible to provide the non-existence proof or total existence proof of the electronic mail without the disclosure of all the electronic mail.

Further, according to the mail management system, each address information which is a mail address or a combination of mail addresses corresponds to individual serial numbers independently assigned to each of the address information, each of the updated serial numbers is stored at the counter storage unit 302. Then, a snapshot indicating the correspondence of the address information and the serial numbers stored at the counter storage unit 302 at a time point. For example, a snapshot may be created each time a backup operation is carried out for the serial number counter.

For example, where it is desired to provide the non-existence proof of electronic mail (e.g., proof that electronic mail from a certain sender to a recipient does not exist for certain periods), the serial number counter at a starting point and a terminating point of “certain periods” is disclosed to the other party, thus making it possible to provide the non-existence proof of electronic mail in a simple manner.

A specific explanation is provided with reference to an example. If mail exists, the corresponding entry (for example, a serial number) should be included in the serial number counter. On the other hand, if there is no corresponding entry, and if, for example, in the serial number counter at a starting point and a terminating point of “certain periods”, there is no increase in serial number corresponding to a relevant mail address, non-existence of the corresponding mail may be proved.

Further, for example, where it is desired to demonstrate the total existence of mail (e.g., mail from a certain sender to a recipient during certain periods is all the relevant mail), all the mail from the sender to the recipient during the periods may be disclosed to the other party, in addition to the serial number counter at a starting point and a terminating point of “certain periods”. Therefore, according to the mail management system of Embodiment 1, it is possible to provide proof while keeping the disclosure of evidence to an acceptable level and/or minimum level possible that still provides the non-existence proof and total existence proof of electronic mail.

In Embodiment 1, an explanation has been provided for a method in which a mail address corresponding to a recipient/sender serial number is used in discriminating between “sender information” and “recipient information”. The present invention shall not be limited thereto and may be used in such a manner that the mail address corresponding to the recipient/sender serial number is used without discriminating between “sender information” and “recipient information”.

Specifically, in the mail management system of Embodiment 2, “sender information” and “recipient information” included in mail are obtained and the obtained mail address corresponds to a recipient/sender serial number without discrimination on whether the mail address is “sender information” or “recipient information”.

In Embodiment 1, different serial numbers independent of each other are assigned, for example, to a combination of sender information “satou”, and recipient information “suzuki”, and a combination of sender information “suzuki”, and recipient information “satou”. However, in Embodiment 2, the mail management system does not discriminate between sender information and recipient information but handles mail so that a combination of sender information “satou”, and recipient information “suzuki”, and a combination of sender information “suzuki”, and recipient information “satou” are the same combination, thereby assigning a sequence of independent serial numbers to electronic mail including both of the combinations.

In other words, in the mail management system of Embodiment 2, the serial number assigning unit 402 does not discriminate between sender information and recipient information but assigns a serial number independent of each mail address to the relevant electronic mail obtained by the mail copy unit 401.

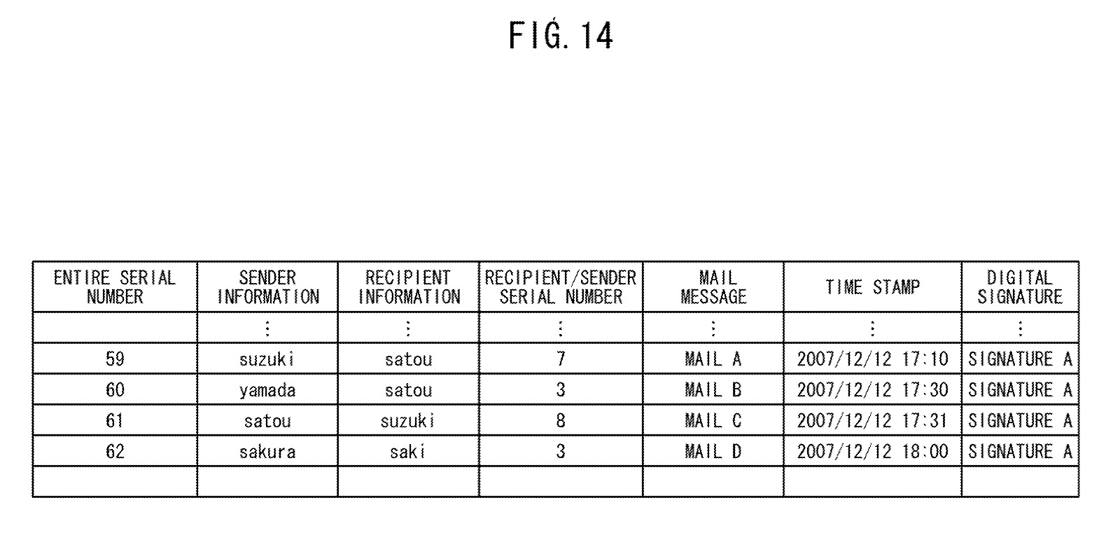

For example, as shown in FIG. 14, in the mail management system of Embodiment 2, after a recipient/sender serial number “7”, is assigned to a combination of sender information “suzuki”, and recipient information “satou”, recipient/sender information is assigned to the combination of sender information “satou”, and recipient information “suzuki”. In this instance, the serial number assigning unit 402 assigns a sequence of serial numbers (e.g., “8” is obtained by adding “1” to “7”) which has been assigned to the combination of sender information “suzuki”, and recipient information “satou”. It is noted that FIG. 14 is a drawing for explaining one of the features of Embodiment 2.

As described above, the management system does not discriminate between sender information and recipient information but assigns a serial number independent of each mail address to the obtained electronic mail. Therefore, it assigns a serial number without discriminating that relevant mail address is sender information or recipient information, thereby making it possible to conduct processing in a simple manner.

In Embodiments 1 and 2, an explanation has been made for a method in which a combination of mail addresses is used to correspond to a recipient/sender serial number. However, the present invention shall not be limited thereto and may use a single mail address to correspond to a recipient/sender serial number.

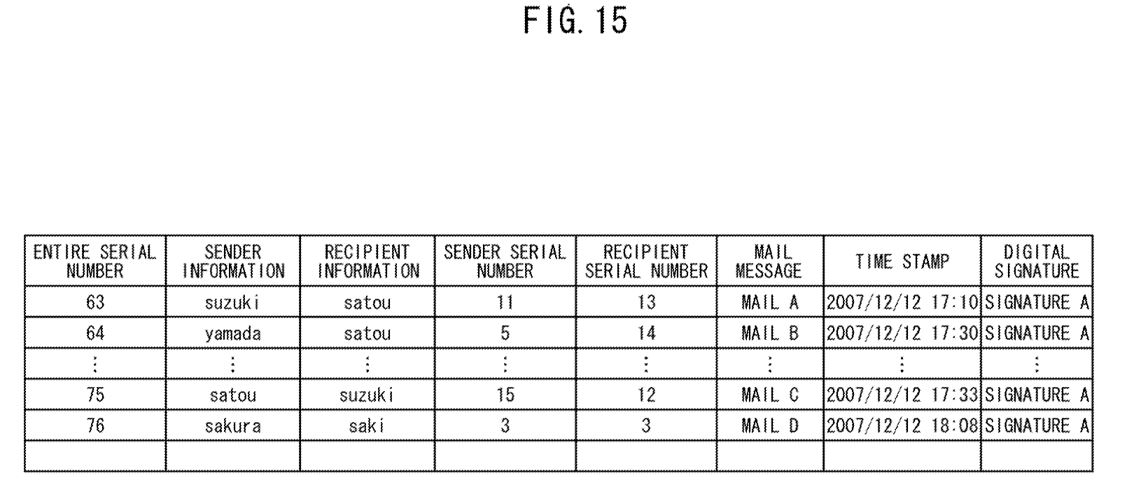

In other words, in the mail management system of Embodiment 3, the serial number assigning unit 402 assigns a serial number independent of each mail address to the electronic mail obtained by the mail copy unit 401. For example, as shown in FIG. 15, in the mail management system of Embodiment 3, the serial number assigning unit 402 assigns a “sender serial number” which is a serial number corresponding to sender information and a “recipient serial number” which is a serial number corresponding to recipient information.

A specific explanation is provided with reference to an example indicated with the entire serial number “63” given in FIG. 15. In the mail management system of Embodiment 3, the serial number assigning unit 402 assigns a sender serial number “11” to sender information “suzuki”, and a recipient serial number “13” to recipient information “satou”. The mail management system of Embodiment 3 discriminates whether the relevant mail address is related to sender information or recipient information, thereby writing it into the processed mail storage unit 103 or the processing mail storage unit 301. However, in the case of the same mail address, it assigns a sequence of the same serial numbers. It is noted that the above discrimination on whether the relevant mail address is related to sender information or recipient information is made for understanding by the mail management system. FIG. 15 is a drawing for explaining one of the features of Embodiment 3.

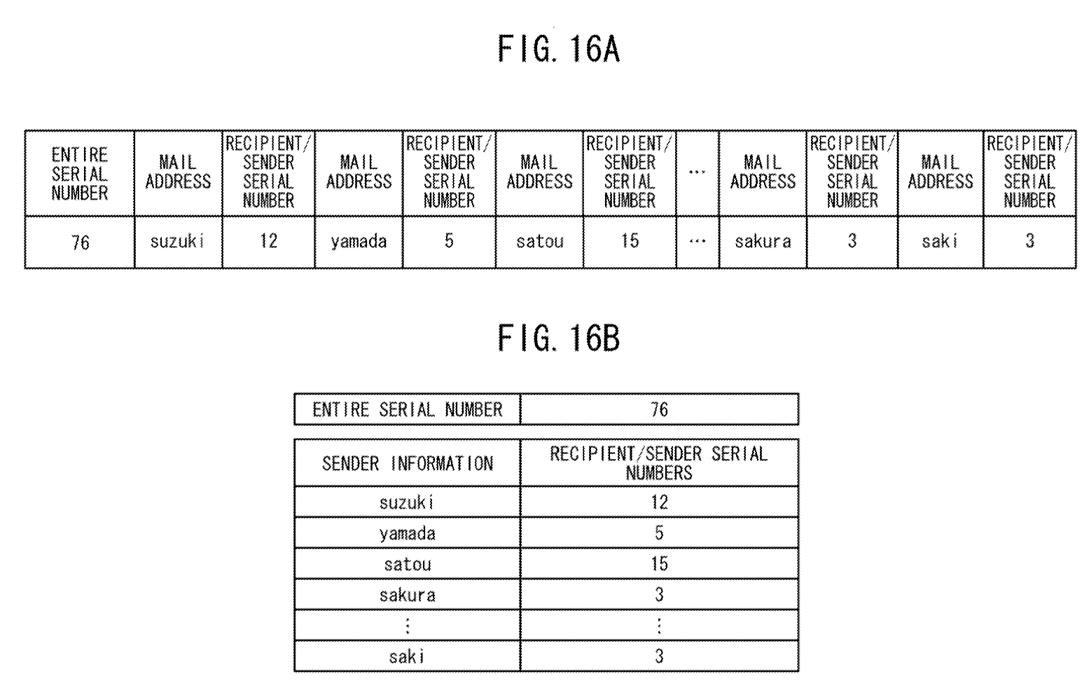

Further, as shown in FIGS. 16A and 16B, in the mail management system of Embodiment 3, for example, the counter storage unit 302 stores a serial number for each mail address. For example, it stores a recipient/sender serial number “12” to correspond to the mail address “suzuki”. FIG. 16 is a drawing for explaining one of the features of Embodiment 3.

As described above, since the mail management system assigns a serial number independent of each mail address to the obtained electronic mail or a serial number is assigned to each mail address, it is possible to carry out processing in a simple manner.

Next, other embodiments will be explained, which are as follows.

For example, in the above-described embodiments, an explanation has been made for a method in which a mail address in itself is used as a mail address corresponding to a recipient/sender serial number. However, the present invention shall not be limited thereto, and a hash value calculated from a mail address may be used. Specifically, the counter storage unit 302 stores a serial number corresponding to each of the hash values calculated from mail address or addresses.

As a result, it is possible to reduce the likelihood of a mail address being directly leaked to the outside in providing the non-existence proof or total existence proof relating to electronic mail.

For example, in a method which stores a serial number corresponding to a mail address, the mail address may be disclosed to others when providing the non-existence proof or total existence proof relating to electronic mail. As a result, there is a case where all the recipients and senders described in the mail exchanged with a certain organization may be leaked. On the other hand, if a mail address is not used directly but a hash value of the mail address is used, it is possible to reduce the likelihood of the mail address being directly leaked to the outside.

In the above-described embodiments, an explanation has been made for a method in which a serial number, a mail address, a mail message and a time stamp, is assigned a digital signature indicating that the information has not been tampered with. The present invention shall not be, however, limited thereto and may assign, individually, different digital signatures to each of the serial number, the mail address, the mail message and the time stamp.

In the above-described embodiments, an explanation has been provided for a method (1) in which a serial number is assigned to each combination of “sender information” and “recipient information”, a method (2) in which no discrimination is made between “sender information” and “recipient information” and a serial number is assigned to each combination of two mail addresses, a method (3) in which a serial number is assigned to each mail address, and a method (4) in which there is used a hash value calculated from a mail address. In this instance, for example, in Embodiment 1, an explanation has been provided for the method (1) to which the present invention shall not be, however, limited thereto. Among the methods of (1) to (4), some or all of them may be combined and executed.

For example, in a method in which (1), (2) and (3) are combined and executed, the mail management system of Embodiment 3 assigns a serial number assigned to each combination of “sender information” and “recipient information”, a serial number assigned to each combination of two mail addresses without discrimination between “sender information” and “recipient information”, and a serial number assigned to each mail address and uses them respectively.

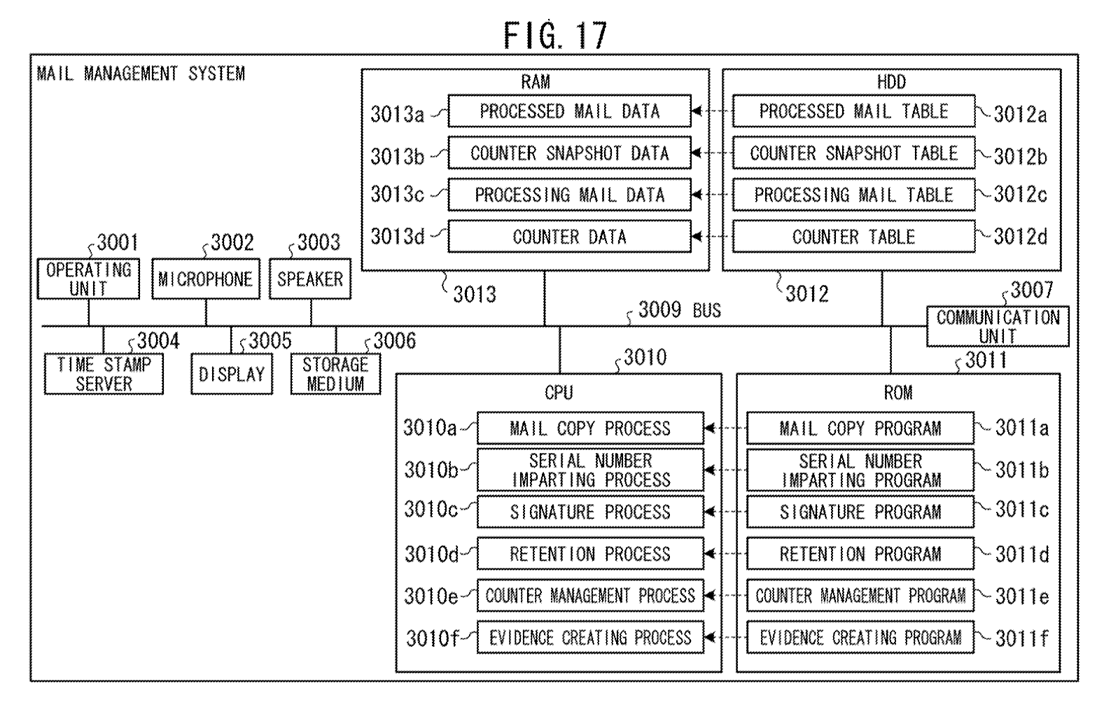

Incidentally, in Embodiment 1 which has been described above, an explanation has been made for a case where hardware logic is adopted to realize various types of processing. However, the present invention shall not be limited thereto and may be applied to a case where a computer includes a processor and memory storing programs executed by the processor to realize various types of processing. Hereinafter, an explanation is provided by referring to FIG. 17 for an example in which a computer, which when executing instructions stored on computer-readable medium, provides a mail management system of Embodiment 1.

As shown in FIG. 17, the mail management system of Embodiment 1 includes an operating unit 3001, a microphone 3002, a speaker 3003, a time stamp 3004, a display 3005, a storage medium 3006, a communication unit 3007, a CPU 3010, a ROM 3011, a HDD 3012 and a RAM 3013 that are connected with a bus 3009, for example.

The ROM 3011 may store, in advance, control programs which function similar to the mail copy unit 401, the serial number assigning unit 402, the signature unit 403, the retention unit 404, the counter management unit 405 and the evidence creating unit 406 described in Embodiment 1. In other words, the ROM 3011 may store a mail copy program 3011a, a serial number assigning program 3011b, a signature program 3011c, a retention program 3011d, a counter management program 3011e and an evidence creating program 3011f. It is noted that these programs 3011a to 3011f may be integrated or separated, whenever necessary, as with a case of individual components of the mail management system given in FIG. 3.

The CPU 3010 reads out these programs 3011a to 3011f from the ROM 3011 and executes them, by which, as shown in FIG. 17, the programs 3011a to 3011f function respectively as the mail copy process 3010a, the serial number assigning process 3010b, the signature process 3010c, the retention process 3010d, the counter management process 3010e and the evidence creating process 3010f.

Then, the HDD 3012 is provided with a processed mail table 3012a, a counter snapshot table 3012b, a processing mail table 3012c and a counter table 3012d.

Then, the CPU 3010 reads out the processed mail table 3012a, the counter snapshot table 3012b, the processing mail table 3012c and the counter table 3012d, and stores the respective tables at the RAM 3013, for example. Further, the CPU 3010 may use processed mail data 3013a, counter snapshot data 3013b, processing mail data 3013c, and counter data 3013d stored in the RAM 3013.

The mail management system explained in the present embodiment can be realized by using a computer such as a personal computer and a workstation to execute a prepared program, for example. The program, which includes executable instructions, may be distributed via a network such as Internet. Further, the program, may be stored on storage media readable by a computer such as a hard disk, a flexible disk (FD), a CD-ROM, an MO and a DVD, and executed by being read out from the storage media by using the computer.

All examples and conditional language recited herein are intended for pedagogical purpose to aid the reader in understanding the principles of the invention and the concepts contributed by the inventor to furthering the art, and are to be construed as being without limitation to such specifically recited examples and conditions, nor does the organization of such examples in the specification related to a showing of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. An electronic mail management system for managing electronic mail, the mail management system comprising:
an obtaining unit to obtain electronic mail whenever the electronic mail is sent or received;
a first assigning unit to assign at least one serial number to the electronic mail obtained by the obtaining unit, each assigned serial number being a number from among a sequence of numbers associated with at least one mail address included in the obtained electronic mail; and
a memory to store the obtained electronic mail in connection with the at least one assigned serial number.

2. The electronic mail management system according to claim 1, further comprising:
a second assigning unit to assign time information to the electronic mail obtained by the obtaining unit; and
the memory stores the assigned time information along with the electronic mail and the assigned serial number.

3. The electronic mail management system according to claim 2, further comprising:
a third assigning unit to assign a digital signature to indicate the electronic mail to which the serial number has been assigned by the first assigning unit and the time information has been assigned by the second assigning unit has not been tampered with; and
the memory also stores the digital signature along with the assigned time information, the electronic email and the assigned serial number.

4. The mail management system according to claim 1, wherein the obtained electronic mail includes electronic mail sent from a mail address to be managed or received incoming electronic mail to the mail address.

5. The mail management system according to claim 1, wherein
the obtained electronic mail includes sender information, which is a mail address identifying a sender sending the electronic mail, and recipient information, which is a mail address identifying a recipient receiving the electronic mail, and
the serial number assigned by the first assigning unit is from a sequence of numbers corresponding to a combination of both the sender information and the recipient information of obtained electronic mail.

6. The mail management system according to claim 5, wherein:
the obtaining unit obtains a second electronic mail including the same combination of both the sender information and the recipient information as a previously-obtained electronic mail; and
the first assigning unit assigns a second serial number to the obtained second electronic mail, the assigned second serial number is a next number in the sequence of the numbers corresponding to the combination of both the sender information and the recipient information.

7. The mail management system according to claim 1, wherein
the obtained electronic email includes a first mail address and a second mail address; and
the serial number assigned by the first assigning unit is from a sequence of number corresponding to a combination of the first mail address and the second mail address.

8. The mail management system according to claim 7, wherein
the first mail address is sender information and the second mail address is recipient information; and
the first assigning unit does not discriminate between the sender information and the recipient information of the obtained electronic mail.

9. The mail management system according to claim 1, wherein
the obtained email includes a plurality of different mail addresses, and
the first assigning unit assigns a plurality of serial numbers to the electronic mail obtained by the obtaining unit, the plurality of serial numbers being from different sequences of numbers respectively corresponding to the plurality of different mail addresses.

10. The mail management system according to claim 1, further comprising:
a counter storage unit to store, at a serial number counter, each assigned serial number corresponding to the at least one mail address; and
a creation unit to create address information from information stored at the serial number counter by the counter storage unit and a snapshot indicating correspondence at a time along with the serial number whenever a backup operation is carried out for the serial number counter.

11. The mail management system according to claim 1, wherein the memory stores the serial number with at least one corresponding hash value calculated based on the at least one mail address.

12. An electronic mail management method for managing electronic mail, the mail management method, comprising:
obtaining electronic mail whenever the electronic mail is sent or received;
assigning at least one serial number to the obtained electronic mail, an assigned serial number being a number from among a sequence of numbers associated with at least one mail address included in the obtained electronic mail; and
storing the obtained electronic mail in connection with the assigned serial number.

13. The electronic mail management method according to claim 12, wherein
the assigning also assigns time information and a digital signature to indicate that the electronic mail to which the serial number and time information has been assigned has not been tampered with, and
the storing stores the assigned digital signature, the assigned time information, the electronic email, and the at least one assigned serial number.

14. The electronic mail management method according to claim 12, wherein the obtained electronic mail includes sender information, which is a mail address identifying a sender sending the electronic mail, and recipient information, which is a mail address identifying a recipient receiving the electronic mail, and
the serial number assigned by the assigning is from a sequence of numbers corresponding to a combination of both the sender information and the recipient information of obtained electronic mail.

15. The electronic mail management method according to claim 12, wherein
the obtained electronic email includes a first mail address and a second mail address; and
the serial number assigned by the assigning is from a sequence of number corresponding to a combination of the first mail address and the second mail address.

16. The electronic mail management method according to claim 12, wherein
the obtained email includes a plurality of different mail addresses, and
the first assigning unit assigns a plurality of serial numbers to the electronic mail obtained by the obtaining unit, the plurality of serial numbers being from different sequences of numbers respectively corresponding to the plurality of different mail addresses.

17. A computer-readable medium storing a mail management program, which when executed by a computer, causes the computer to perform a method, the method comprising:
obtaining electronic mail whenever the electronic mail is sent or received;
assigning at least one serial number to the obtained electronic mail, an assigned serial number being a number from among a sequence of numbers associated with at least one mail address included in the obtained electronic mail; and
storing the obtained electronic mail in connection with the assigned serial number.

18. The computer-readable medium according to claim 17, wherein
the assigning also assigns time information and a digital signature to indicate that the electronic mail to which the serial number and time information has been assigned has not been tampered with, and
the storing stores the assigned digital signature, the assigned time information, the electronic email, and the at least one assigned serial number.

19. The computer-readable medium according to claim 17, wherein the obtained electronic mail includes sender information, which is a mail address identifying a sender sending the electronic mail, and recipient information, which is a mail address identifying a recipient receiving the electronic mail, and
the serial number assigned by the assigning is from a sequence of numbers corresponding to a combination of both the sender information and the recipient information of obtained electronic mail.

20. The computer-readable medium according to claim 17, wherein
the obtained electronic email includes a first mail address and a second mail address; and
the serial number assigned by the assigning is from a sequence of number corresponding to a combination of the first mail address and the second mail address.
